(19) United States
(12) Patent Application Publication
(10) Pub. No.: US 2020/0371550 A1
(43) Pub. Date: Nov. 26, 2020

(54) TRI-FOLDING ELECTRONIC DEVICE WITH DISPLAY

(71) Applicant: Diana Igorevna Polyakova, (US)

(72) Inventor: Valery Rostislavovich Polyakov, Lafayette, CA (US)

(73) Assignee: Diana Igorevna Polyakova, Lafayette, CA (US)

(21) Appl. No.: 16/419,060

(22) Filed: May 22, 2019

(51) Int. Cl. G06F 1/16

(52) U.S. Cl. CPC G06F 1/1616; G06F 1/1647; G06F 1/1652

(57) ABSTRACT

Large display is beneficial for electronic devices such as personal computers, tablets, cell phones, and watches. There is a tendency to minimize the size of such devices, so that they can fit in a brief case, pocket, or be comfortably worn on the wrist. Such device comprises at least four flexibly attached housings with either three or more separate rigid displays or a flexible and bendable display attached to one side. This side will be covered when the device is folded. The other side may have one or two rigid displays for use when the device is folded or unfolded. The housing parts may be connected to each other using hinges, rotational elements, or any other mechanical interfaces that allow rotational repositioning of the housing parts relative to each other and securing their positions in a desired configuration.

### BACKGROUND

The invention relates to electronic devices that can be folded to become more compact. Such devices may be equipped with flexible displays or three rigid displays on the side that is not visible, when folded. Electronic devices, such as personal computers, tablets, cell phones, and smart watches are often provided with liquid crystal displays. Such displays are often covered with a rigid layer of cover glass. The cover glass protects displays from mechanical damage. The glass cover is often too rigid and does not allow the display to be bent.

Flexible display technologies allow displays to be bent. Bendable displays allow smaller devices to be folded for storage, but have a larger display, when unfolded.

### BRIEF DESCRIPTION OF THE DRAWING

FIG. 1 is a side view of an illustrative electronic device 1 in an unfolded state.

### DETAILED DESCRIPTION

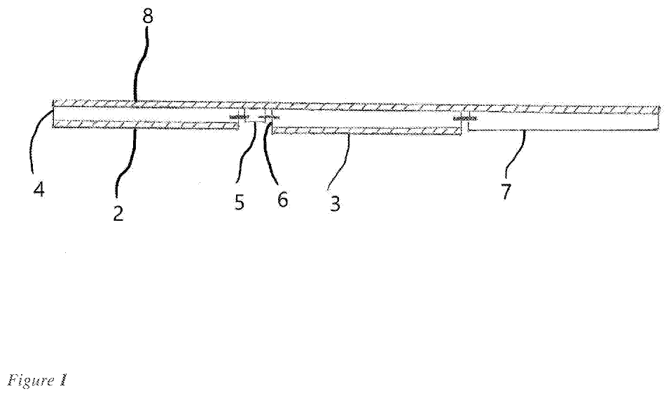

An illustrative electronic device is shown in an unfolded state in FIG. 1. Electronic device 1 may be any portable electronic device including but not limited to a laptop, a tablet, a cell phone, or a smart watch. Device 1 may include additional electronic components typically found in laptop, a tablet, a cell phone, or a smart watch as well as other components specifically designed for device 1.

Electronic device 1 may have a single flexible display 8. Such display may be based on any existing display technology including, but not limited to electronic ink displays, LED, OLED, or any other type of flexible displays. Flexible display 8 could be mounted to cover the upper sides, as shown in FIG. 1, of housings 4, 5, 6, and 7.

In an alternative, electronic device 1 may also have a set of three rigid displays mounted in place of the flexible display 8 described above. In this case the displays will be attached to housings 4, 6, and 7, but not 5. Alternatively, in place of display 8, there may be any combination of flexible and rigid displays, where, for example, a flexible display is only attached to housings 6, and 7 and a rigid display covers the upper portion (FIG. 1) of housing 8.

Device 1 may have a keyboard that is physically attached to the device. In this case, the keyboard in the folded state can be used as a part of a protective cover for the displays 2 or 3. Alternatively, the keyboard could be connected to device 1 using a wire, for example USB connection, or wirelessly, for example using Bluetooth technology.

In order to use device 1 in a folded state, it may be equipped with additional displays 2 or/and 3 located on the sides opposing the large display 8 as illustrated by FIG. 1. These displays could, for example, be only activated in the folded state. Alternatively, displays 2 or/and 3 can be used to simplify collaboration among users by allowing additional users to sit on the opposite side of the main user and view presentations displayed by the main user. Such arrangement could be particularly beneficial, if device 1 is a laptop computer with a keyboard. Housing 4 or 5 may be partially decoupled from the rest of the device to allow some degree of rotational flexibility along a different from folding axis permitting viewing at a different angle from the rest of the active displays, when in an unfolded or partially unfolded state.

The length of housing 5 is selected to be at least equal to the width of housing 7, so that the device can be folded and secured in the folded state. The edges of housings 4, 6 and 7 may have features to lock device 1 in the folded state.

Housings 4, 5, 6, and 7 may be connected to each other using hinges, rotational elements, or any other mechanical interfaces that allow rotational repositioning of the housings relative to each other and securing their positions in a stable configuration. Signals may be routed between each pair of connected housings.

Device 1 could also be operated in a partially folded state. The mechanical devices connecting the housings have to allow such relative positioning of the housings.

The foregoing is just an illustration of the principles and ideas of this invention. Various modifications and alterations can be made by persons skilled in the art without departing from the scope and spirit of the invention.

What claimed is:

1. An electronic device, comprising:
a first housing undetachable and connected to the second housing only;
the second housing undetachable and connected to first and third housings only;
the third housing undetachable and connected to second and fourth housings only;
the fourth housing undetachable and connected to third housing only,
wherein the width of the second housing is selected to be greater than the depth of the fourth housing so that the first housing can be folded over the top of the fourth housing;
either three separate rigid displays covering same sides of the first, the third, and the fourth housings; or a flexible display covering all or almost all of the said housings on one side; or one flexible display attached to the same sides of the third and the fourth housings and an additional rigid display attached to the first housing;
mechanical connectors between the first housing and the second housing, between the second housing and the third housing, and between the third housing and the fourth housing that enable the housings to fold over top of each other; and
electrical connectors between the first housing and the second housing, between the second housing and the third housing, and between the third housing and the fourth housing permitting signals to pass between said housings during the folding process and when fully folded or unfolded.

2. The electronic device defined in claim 1 containing an additional display region on the opposite side of the third housing.

3. The electronic device as in any one of claim 1 or 2, further containing an additional display region on the opposite side of the first housing.
